(19) United States
(12) Patent Application Publication
(10) Pub. No.: US 2026/0140070 A1
(43) Pub. Date: May 21, 2026

(54) METHOD FOR OBTAINING AT LEAST ONE MEASUREMENT OF AT LEAST ONE SEMICONDUCTOR STRUCTURE IN A WAFER FROM ONE OR MORE WEDGE CUTS, AND CORRESPONDING SYSTEM

(71) Applicant: Carl Zeiss SMT GmbH, Oberkochen (DE)

(72) Inventors: Abhilash SRIKANTHA, Neu-Ulm (DE); Dmitry KLOCHKOV, Schwaebisch Gmuend (DE); Anna ALPEROVICH, Neu-Ulm (DE); Johannes PERSCH, Etgert (DE); Johannes DIETERLE, Aalen (DE)

(21) Appl. No.: 19/446,232

(22) Filed: Jan. 12, 2026

Related U.S. Application Data
(63) Continuation of application No. PCT/EP2024/067872, filed on Jun. 25, 2024.

(30) Foreign Application Priority Data
Jul. 19, 2023 (DE) 10 2023 119 147.0

(51) Int. Cl. G01N 23/04; G01N 1/28; G06T 5/60

(52) U.S. Cl. CPC G01N 23/04; G01N 1/286; G06T 5/60; G06T 2207/10061; G06T 2207/20081; G06T 2207/20084; G06T 2207/30148

(57) ABSTRACT

A method obtains at least one measurement of at least one semiconductor structure in a wafer. The method comprises obtaining a wedge cut of an inspection volume of the wafer by exposing a cross section surface in the inspection volume by milling into the inspection volume with a FIB column at a slant angle GF. The method further comprises imaging the cross section surface with a charged particle beam imaging system. In addition, the method comprises extracting a region of interest of the wedge cut comprising a cross section of the at least one semiconductor structure, and using a trained machine learning model to map the region of interest of the wedge cut to a 3D reconstruction of the region of interest. The method also comprises obtaining at least one measurement from the 3D reconstruction.

### CROSS-REFERENCE TO RELATED APPLICATIONS

The present application is a continuation of, and claims benefit under 35 USC 120 to, international application No. PCT/EP2024/067872, filed Jun. 25, 2024, which claims benefit under 35 USC 119 of German Application No. 10 2023 119 147.0, filed Jul. 19, 2023. The entire disclosure of each of these applications is incorporated by reference herein.

### FIELD

The disclosure relates to a three-dimensional circuit pattern measurement method of semiconductor structures within a semiconductor wafer. The disclosure relates to a method, computer program product and a corresponding system for measuring parameters of semiconductor structures such as high aspect ratio (HAR) structures with increased accuracy. The method, computer program product and system can be utilized for quantitative metrology, defect detection, process monitoring, or defect review of integrated circuits within semiconductor wafers.

### BACKGROUND

Manufacturing of wafers comprising semiconductor structures includes a relatively complex sequence of deposition and removal of physical substances at nano-scale resolutions. Therefore, extracting measurements such as inter- and intra-structure distances of the manufactured 3D structures is relevant for monitoring the manufacturing processes.

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes.

Fabricated semiconductor structures are typically based on prior knowledge. The semiconductor structures are manufactured from a sequence of layers being parallel to a substrate. For example, in a logic type sample, metal lines run parallel in metal layers or HAR structures and metal vias run perpendicular to the metal layers. The angle between metal lines in different layers is typically either 0° or 90°. On the other hand, for VNAND type structures it is known that their cross-sections are circular on average. Furthermore, a semiconductor wafer typically has a diameter of 300 mm and comprises a plurality of several sites, so called dies, each comprising at least one integrated circuit pattern such as for example for a memory chip or for a processor chip. During fabrication, semiconductor wafers run through about 1,000 process steps, and within the semiconductor wafer, about 100 and more parallel layers are formed, comprising the transistor layers, the layers of the middle of the line, and the interconnect layers and, in memory devices, a plurality of 3D arrays of memory cells.

Dimensions, shapes and placements of the semiconductor structures and patterns can be subject to several influences. Part of the manufacture includes using a photolithography process. Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., using optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks are expected to be able to image increasingly smaller structures onto wafers. The aspect ratio and the number of layers of integrated circuits is constantly increasing and the structures are growing into third (vertical) dimension. The current height of the memory stacks exceeds a dozen of microns. In contrast, the feature size is becoming smaller. The minimum feature size or critical dimension is below 10 nm, for example 7 nm or 5 nm, and is expected to approach feature sizes below 3 nm in near future. While the complexity and dimensions of the semiconductor structures are growing into the third dimension, the lateral dimensions of integrated semiconductor structures are becoming smaller. Producing the relatively small structure dimensions imaged onto the wafer uses photolithographic masks or templates for nanoimprint photolithography with ever smaller structures or pattern elements.

As this fabrication process can be complicated and relatively non-linear, optimization of production process parameters can be difficult. As a remedy, an iteration scheme called process window qualification (PWQ) can be applied. In each iteration a test wafer is manufactured based on the currently best process parameters, with different dies of the wafer being exposed to different manufacturing conditions. By detecting and analyzing the test structures with devices for quantitative metrology and defect-detection, the best manufacturing process parameters can be selected. In this way, production process parameters can be tweaked towards optimality.

On account of the relatively small structure sizes of the pattern elements of photolithographic masks or templates and the complex production process of semiconductor structures, it is not possible to exclude errors during wafer production. Hence, in semiconductor process control wafer inspection, review, and metrology play a role to monitor defects. Traditionally, measurements of 2D semiconductor structures were taken manually by experts. However, due to the three-dimensionality of the semiconductor structures on the wafer, three-dimensional measurements are desired, which can allow for a more accurate monitoring of the production process.

To obtain a 3D-imaging dataset, e.g., an imaging dataset comprising multiple 2D cross sections of the wafer, destructive imaging techniques using focused ion beam scanning electron microscopy (FIB-SEM) can be used. The generated imaging datasets are relatively dense (e.g., comprising thousands of images) and, therefore, can be challenging with respect to scalability, robustness and repeatability for taking measurements.

For example, WO 2021/083581 A1 discloses a method for measuring shape deviations of 3D HAR structures in FIB-SEM tomography. The method comprises obtaining an imaging dataset of 2D cross section images parallel to the wafer surface using a slice and imaging technique. A template of cross section image features representing a HAR structure of interest is generated, and instances of this template are detected in the 2D cross section images of the imaging dataset. The detected instances are assigned to different 3D HAR structures, e.g., based on the distance of the center coordinates of the instances in adjacent 2D cross section images. From the detected instances assigned to the same 3D HAR structure the surface of the 3D HAR structure is reconstructed and parameters characterizing the geometry of the entire semiconductor structure are obtained.

Obtaining parallel slices of a wafer for measuring parameters of semiconductor structures can use large amounts of data and leads to low throughput. To reduce the amount of data for measuring parameters of semiconductor structures, WO 2021/180600 A1 discloses a method for measuring parameters using wedge cuts, i.e., cross section images obtained by milling into the wafer using a FIB SEM at a slanted angle, such as between 25° and 45°, with respect to the wafer surface. In the wedge cut the depth of a pixel can be obtained from its lateral position.

When using wedge cuts for taking measurements of semiconductor structures, however, difficulties can arise when the measurements of the parameters of the semiconductor structures are affected by depth-dependent interfering structures. Such depth-dependent interfering structures generally occur only at some depths in the wafer. When taking parallel cross sections of the wafer, measurements of parameters can be obtained from cross sections without these interfering structures, or at least the interaction of the interfering structures with the semiconductor structures can be modeled in a simple way. Wedge cuts, however, in general always contain these interfering structures, since they cover all depths of the wafer, and the interaction of the interfering structures with the semiconductor structures can be difficult to model. Thus, the measurements obtained from wedge cuts often lack accuracy due to the interfering structures.

For example, channels are high aspect ratio (HAR) structures that run through a number of word-lines. By diagonally slicing through the wafer, the HAR structures and the word-lines are diagonally sliced. Consequently, some HAR structures in the wedge cuts show an overlap with word-lines and some do not. Depending on the depth in the wafer, the overlap of HAR structures and word-lines differs. This can make it difficult to accurately determine parameters of the HAR structures such as diameters, which can, for example, be used to measure center points or the thickness of different materials of the HAR structures. Other interfering structures can, for example, be deck-transitions.

### SUMMARY

The disclosure seeks to provide an accurate method for taking measurements of 3D semiconductor structures from wedge cuts, such as from a single wedge cut. The disclosure seeks to take accurate measurements of 3D semiconductor structures from wedge cuts in case of interfering structures such as word-lines or deck-transitions. The disclosure seeks to obtain measurements of 3D semiconductor structures relatively quickly and with increased throughput. The disclosure seeks to obtain measurements of 3D semiconductor structures with low memory. The disclosure seeks to provide a method for reviewing critical dimensions of semiconductor structures on a wafer. The disclosure seeks to provide a method for process window qualification. The disclosure seeks to increase the throughput during quality control or quality assurance processes for wafers. The disclosure seeks to minimize runtimes of quality control or quality assurance methods.

Embodiments of the disclosure concern methods, computer programs, computer-readable media and systems for obtaining at least one measurement of at least one semiconductor structure in a wafer.

A first embodiment of the disclosure includes a method for obtaining at least one measurement of at least one semiconductor structure in a wafer, the method comprising: obtaining a wedge cut of an inspection volume of the wafer by exposing a cross section surface in the inspection volume by milling into the inspection volume with a focused ion beam (FIB) column at a slant angle GF, and imaging the cross section surface with a charged particle beam imaging system to obtain the wedge cut; extracting a region of interest of the wedge cut comprising a cross section of the at least one semiconductor structure; using a trained machine learning model to map the region of interest of the wedge cut to a 3D reconstruction of the region of interest; and obtaining at least one measurement of the at least one semiconductor structure from the 3D reconstruction of the region of interest of the wedge cut.

In an example, at least one semiconductor structure of the at least one semiconductor structure that is to be measured is a high aspect ratio structure. High aspect ratio structures often occur in memory structures in wafers and can be relatively easily measured using wedge cuts due to their repetitive structure.

In an example, the at least one measurement is from the group comprising a position, a radius, a diameter, a length, a distance, an area, an angle, an ellipticity, an aspect ratio, a curvature, a periodicity, a polygon parameter, a tilt.

A wedge cut refers to a 2D image of a cross section surface of a wafer. The cross section surface is obtained by milling into the wafer with a FIB column at a slant angle between 20° and 60° with respect to a surface of a wafer support table. The slant angle GF can lie within the range of 25° and 45°, such as within the range of 30° and 36°, relative to the wafer surface. The image of the cross section surface is obtained by imaging the cross section surface using a charged particle beam imaging system.

A region of interest comprises a subset of the wedge cut of an arbitrary shape, e.g., a geometric shape such as a bounding box, a circle, or any other connected region of the wedge cut, which comprises the at least one semiconductor structure. Throughout this disclosure, a region of interest comprises a semiconductor structure if the region of interest comprises at least a portion of the semiconductor structure.

Machine learning is a field of artificial intelligence. Machine learning methods are data-driven methods that learn underlying concepts automatically from training data such that the problem is solved optimally and automatically without humans having to define rules or additional high-level knowledge. Machine learning methods generally build a parametric machine learning model based on training data. After training, the method is able to generalize the knowledge gained from the training data to new previously unencountered samples, thereby making predictions for new data. There are many machine learning methods, e.g., linear regression, k-means, support vector machines, neural networks or deep learning approaches comprising transformer architectures.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation by using different filters, thus deriving low and high level knowledge from the training data. The hidden layers can have differing sizes and tasks such as convolutional or pooling layers.

Wedge cuts derive only 2D information from 3D structures, thereby saving a lot of computation time and memory space and achieving a high throughput. However, the accuracy of measurements obtained from wedge cuts is limited. Thus, according to the disclosure, a trained machine learning model is used to obtain a “virtual” 3D reconstruction of the region of interest of the wedge cut. The 3D reconstruction contains more information than the 2D region of interest and can, thus, be used to obtain more accurate measurements from the 2D wedge cut. At the same time, the application of a machine learning model during inference is very fast. Thus, both highly accurate measurements and a high throughput can be achieved.

The accuracy of the measurements can be improved, if the region of interest of the wedge cut comprises one or more interfering structures that affect the at least one measurement of the at least one semiconductor structure. Interfering structures refer to semiconductor structures of the wafer that affect the process of taking measurements of semiconductor structures of interest of the wafer. For example, interfering structures refer to semiconductor structures that are in contact with, touch or overlay the semiconductor structures of interest. For example, word-lines or deck-transitions are interfering structures during the process of taking measurements of memory channels.

Wedge cuts often contain interfering structures, e.g., word-lines or deck-transitions, etc., that affect measurements of the semiconductor structures in the wedge cut. Such interfering structures often occur only at specific depths in the wafer, e.g., structures that run parallel to the wafer surface. For example, the one or more interfering structures can be oriented in a direction parallel to the wafer surface at specific depths in the wafer. Thus, when using a common slice and imaging technique that generates slices parallel to the wafer surface some of the slices contain interfering structures and some do not. In this situation, measurements can be taken by relying on slices that do not contain the interfering structures or by using linear models to model the interaction of the semiconductor structures and the interfering structures. However, decomposing an inspection volume of a wafer into slices involves a lot of time and memory due to large amounts of generated data and leads to low throughput. Therefore, wedge cuts can be used instead. Yet, in wedge cuts the interactions between semiconductor structures and interfering structures are often non-linear and cannot be modeled by linear models. By training a machine learning model for the 3D reconstruction of a 2D region of interest of a wedge cut, the non-linear interactions can be modeled automatically, and accurate measurements can be obtained from the 3D reconstruction. Thus, by using a trained machine learning model to obtain a 3D reconstruction of the region of interest of the wedge cut, measurements can be taken from the 3D reconstruction instead of directly from the 2D wedge cut. In this way, the accuracy of the measurements is increased.

In an example, the depth range of the 3D reconstruction of the region of interest corresponds to the depth range of the region of interest in the wedge cut. The 3D reconstruction can, thus, be viewed as a virtual data augmentation of the wedge cut, which enables specifically accurate metrology operations.

According to an embodiment of the disclosure, the 3D reconstruction of the region of interest comprises slices that are parallel to the wafer surface. In this way, a 3D reconstruction of the region of interest in the form of a volume comprising slices simulating a common slice and imaging approach can be obtained from the wedge cut. For example, in case of interfering structures running parallel to the wafer surface the non-linear interactions of the semiconductor structures and the interfering structures can be resolved to linear interactions in the slices parallel to the wafer surface. Thus, the accuracy of measurements obtained from slices parallel to the wafer surface can be combined with the high speed and throughput of a wedge cut metrology method.

In an example of the embodiment of the disclosure, the region of interest of the wedge cut comprises an interfering structure that affects the measurement, and at least one slice of the 3D reconstruction does not contain the interfering structure. In this case, the at least one slice of the 3D reconstruction without interfering structure is specifically useful for taking accurate measurements.

In an example, the trained machine learning model additionally maps the extracted region of interest of the wedge cut to one or more features of the at least one semiconductor structure. The one or more features are from the group comprising contours, contour sections, points, lines, geometric structures (polygons, circles, ellipses, etc.), edges. From these features measurements can be derived. By directly mapping the region of interest to the one or more features, the step of extracting features from the 3D reconstruction is also accomplished by the machine learning model. The machine learning model is, thus, trained to directly extract the features from the wedge cut. Therefore, rule-based or error-prone subsequent algorithms for feature extraction do not have to be applied to the 3D reconstruction. Instead, the features are learned from training data in a data-driven way. In this way, computation time can be saved, more accurate measurements can be obtained, and the user effort for extracting features from 3D reconstructions is reduced.

A single wedge cut can be used to generate the 3D reconstruction. In this way, the throughput can be increased the most. Alternatively, two or more wedge cuts comprising the same at least one semiconductor structure can be used to obtain the 3D reconstruction. In this way, the accuracy can be further improved due to the additional information in the additional wedge cuts. Thus, according to an embodiment of the disclosure, a number N≥2 of wedge cuts of the inspection volume of the wafer for different slant angles GF are obtained, a region of interest comprising a cross section of the at least one semiconductor structure is extracted from each wedge cut, the trained machine learning model maps the N regions of interest of the N wedge cuts to a 3D reconstruction of the N regions of interest, and at least one measurement of the at least one semiconductor structure is obtained from the 3D reconstruction of the N regions of interest of the N wedge cuts.

The at least two wedge cuts can be of different modalities by detecting different kinds of radiation emitted from the wafer. A SEM scans the surface of the wafer using an electron beam with a specified landing energy. The electrons either interact with the wafer and cause an emission of secondary electrons (SE) or they directly bounce off the wafer as back-scattered electrons (BSE). The SE can be detected using, for example, an InLens detector, and the BSE can be detected using, for example, a secondary electron secondary ion (SESI) detector. The detectors can be coupled to a computer system that generates an image of the wafer by counting the emitted electrons per dwell point. The interaction of BSE with the wafer can be limited to the region close to the surface of the wafer yielding a small interaction volume. Therefore, the generated images can have high resolution. On the other hand, the SE typically emanate from regions further below the surface of the wafer yielding a larger interaction volume. Therefore, the generated images are of relatively low resolution but can contain information from further below the surface of the wafer. Apart from SE and BSE, XRays are also emitted from the wafer, from regions even further below the surface of the wafer yielding an even larger interaction volume. Therefore, the generated images are usually of even lower resolution but can contain information from even further below the surface of the wafer. Wedge cuts generated using different kinds of radiation differ in their resolution and in the interaction volume. Thus, they contain different material or morphological information that can be useful for obtaining measurements of semiconductor structures.

In an example, the method for obtaining measurements of semiconductor structures according to an embodiment described above further provides an uncertainty measure for the at least one measurement of the at least one semiconductor structure. Using the uncertainty measure, additional information about the uncertainty of the machine learning model with respect to the obtained measurements can be derived and used in further processing steps.

A computer implemented method, according to an embodiment of the disclosure, is used for training a machine learning model, which maps one or more regions of interest of one or more wedge cuts to a 3D reconstruction of the one or more regions of interest, for use of the trained machine learning model in a method according to an embodiment of the disclosure described above. In an example, the machine learning model maps a single region of interest of a single wedge cut to a 3D reconstruction of the region of interest. The training data for training the machine learning model can comprise regions of interest of wedge cuts and corresponding 3D reconstructions. In an example, the training data is obtained from one or more 3D inspection volumes of wafers comprising slices parallel to the wafer surface and wedge cuts through the one or more 3D inspection volumes. In case a single region of interest of a single wedge cut is used as input to the machine learning model, the training data can comprise pairs each containing a region of interest of a wedge cut and corresponding sections of slices parallel to the wafer surface. In case two or more regions of interest of two or more wedge cuts comprising the same semiconductor structure are used as input to the machine learning model, the training data can comprise pairs each containing two or more regions of interest of two or more wedge cuts comprising the same semiconductor structure and corresponding sections of slices parallel to the wafer surface. In this way, training data can be efficiently generated. By training the machine learning model to reconstruct virtual 3D slices parallel to the wafer surface, measurements from these 3D slices can be obtained during inference, even though only a single wedge cut is acquired of the wafer. Thus, accuracy and throughput can be improved.

A computer program according to an embodiment of the disclosure comprises instructions which, when the program is executed by a computer, cause the computer to carry out a method of any one of the examples or embodiments described above, comprising, for example the training or application of the machine learning model and the derivation of measurements from the 3D reconstruction of the region of interest.

A computer-readable medium according to an embodiment of the disclosure has stored thereon a computer program executable by a computing device, the computer program comprising code for executing a method of any one of the examples or embodiments described above.

A system according to an embodiment of the disclosure comprises: a dual beam device comprising a charged particle beam imaging system and a FIB column configured to obtain at least one wedge cut of a wafer; one or more processing devices; and one or more machine-readable hardware storage devices comprising instructions that are executable by the one or more processing devices to perform operations comprising a method according to any of the examples or embodiments described above.

The disclosure described by examples and embodiments is not limited to the embodiments and examples but can be implemented by those skilled in the art by various combinations or modifications thereof.

### BRIEF DESCRIPTION OF THE DRAWINGS

FIG. 1A illustrates a schematic diagram of a 3D memory structure;

FIG. 1B illustrates desired measurements of HAR structures in metrology applications;

FIG. 2A illustrates an imaging setup for imaging cross sections parallel to the surface of the wafer;

FIG. 2B shows cross section images corresponding to the cross sections in FIG. 2A;

FIG. 3 illustrates a dual beam device for obtaining wedge cuts of wafers;

FIG. 4A illustrates a sparse imaging setup for imaging a wedge cut of a 3D memory structure;

FIG. 4B shows non-linear interactions of interfering structures (word-lines) with semiconductor structures (channels) in a wedge cut;

FIG. 5 illustrates a flow chart of a method for obtaining at least one measurement of at least one semiconductor structure in a wafer according to an embodiment of the disclosure;

FIG. 6 illustrates the generation of a 3D reconstruction of a region of interest of a wedge cut using a machine learning model;

FIG. 7 shows measurements in the form of four different diameters that can be derived from the 3D reconstruction using one or several of the reconstructed slices;

FIG. 8 illustrates the generation of a 3D reconstruction and corresponding features in the form of contours from a region of interest of a wedge cut using a machine learning model;

FIG. 9 illustrates a flow chart of a method for obtaining at least one measurement of at least one semiconductor structure using multiple wedge cuts according to an embodiment of the disclosure; and

FIG. 10 schematically illustrates a system according to an embodiment of the disclosure, which can be used for obtaining at least one measurement of at least one semiconductor structure on a wafer.

### DETAILED DESCRIPTION

In the following, certain exemplary embodiments of the disclosure are described and schematically shown in the figures. Throughout the figures and the description, same reference numbers are used to describe same features or components. Dashed lines indicate optional features.

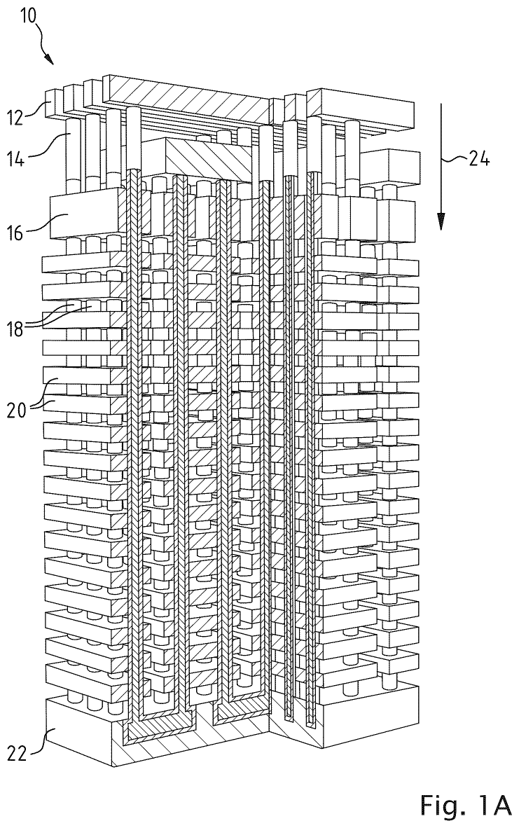

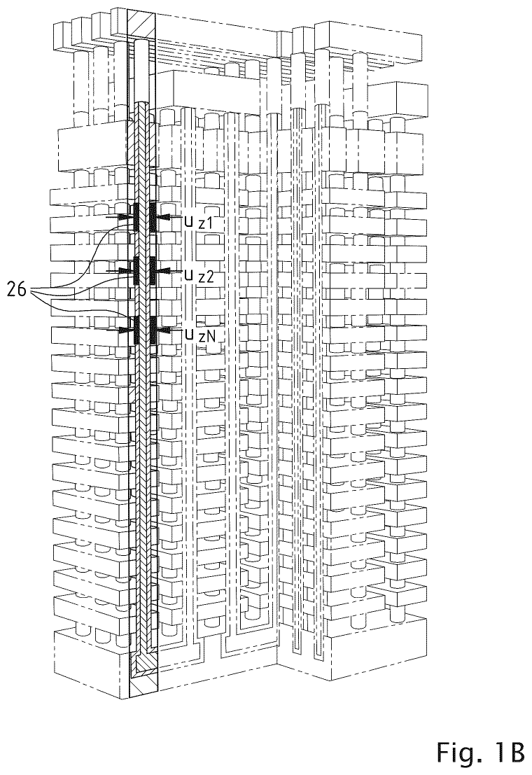

FIG. 1A illustrates a schematic diagram of a 3D memory structure 10, a NAND-structure. The top and bottom portions of the structure pertain to gate logic and comprise bit lines 12, source lines 14, select gates 16, and back gates 22. Semiconductor structures 18, e.g., densely arranged HAR structures such as channels, interact with interfering structures 20, e.g., word-lines or deck-transitions, at specific depths of the wafer. The interfering structures 20 are oriented in a direction parallel to the wafer surface at specific depths 24 in the wafer. The interfering structures 20 affect the measurements of the semiconductor structures 18. Depending on their depth 24 in the 3D memory structure, the interfering structures 20 either interfere with the semiconductor structures 18 or not. FIG. 1B illustrates desired measurements 26 u_{z1}, u_{z2}, . . . , u_{zN} of semiconductor structures 18 for metrology applications, e.g., channel diameters at various depths 24.

To take measurements of 3D semiconductor structures, cross section images can be used. These cross section images can be generated using a dual beam device comprising at least a FIB column and a charged particle beam imaging system, e.g., a scanning electron microscope (SEM).

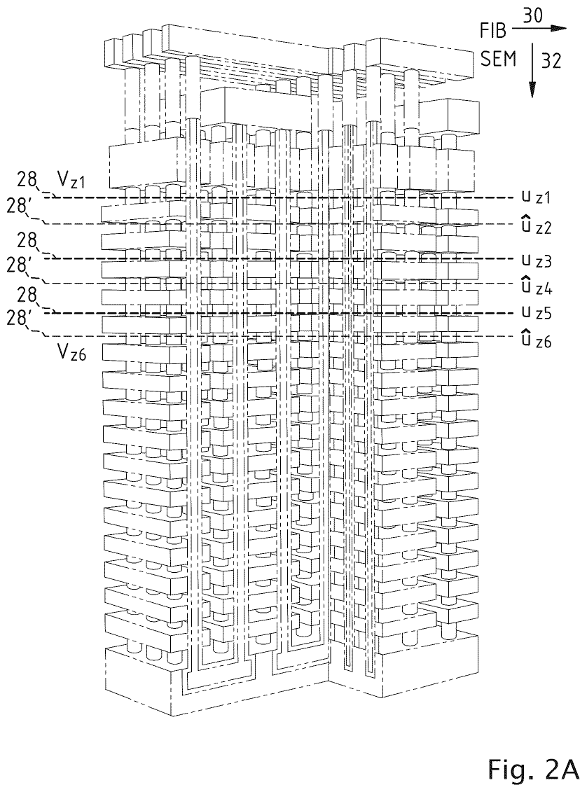

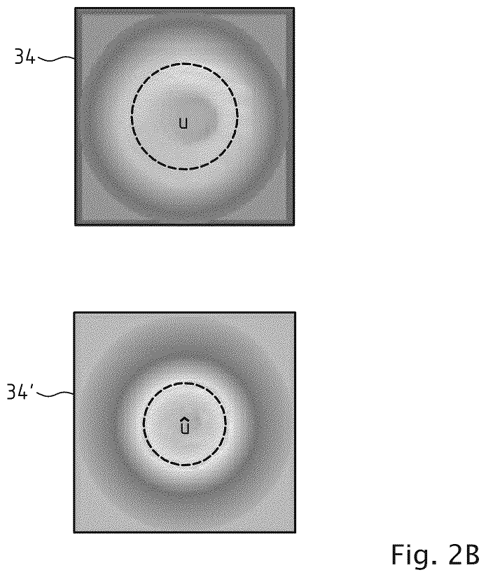

FIG. 2A illustrates a common imaging setup for imaging cross section surfaces 28, 28′ parallel to the surface of the wafer. The FIB column mills the surface of the wafer in the FIB direction 30 parallel the surface of the wafer, thereby forming a cross section surface 28, 28′ of the wafer. The charged particle beam imaging system, e.g., in form of a SEM, images the cross section surface 28, 28′ in the SEM direction 32 orthogonal to its surface, thereby forming cross section surfaces (v_{z1}, . . . , v_{z6}) comprising interference-free cross section surfaces 28 and interfered cross section surfaces 28′. The interference-free cross section surfaces 28 (u_{z1}, u_{z3}, u_{z5}) do not contain interfering structures 20. The interfered cross section surfaces 28′ (û_{z2}, û_{z4}, û_{z6}) comprise semiconductor structures 18, e.g., channels, and interfering structures 20, e.g., word-lines.

FIG. 2B shows cross section images 34, 34′ corresponding to the cross section surfaces 28, 28′. The interference-free cross section image 34 corresponds to the interference-free cross section surfaces 28, whereas the interfered cross section image 34′ corresponds to the interfered cross section surfaces 28′. Since the cross section images 34, 34′ either contain interfering structures 20 or not, the measurements 26 can be compensated by linear models. Alternatively, only interference-free cross section images 34 can be used to obtain measurements 26.

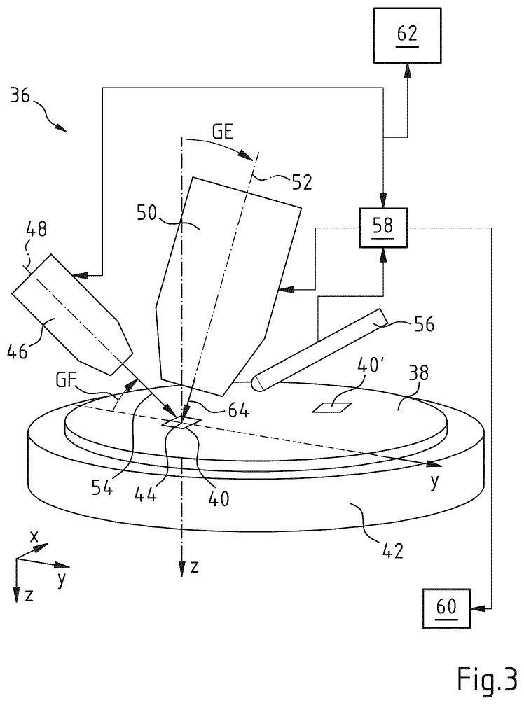

FIG. 3 illustrates a dual beam device 36 for obtaining wedge cuts of wafers 38. A wafer 38 is provided, with several measurement sites 40 and 40′ with the measurement sites for example defined in a location map generated from an inspection tool or from design information. The wafer 38 is placed on a wafer support table 42. A measurement site 40 of the wafer 38 is aligned with a five-axis wafer stage (not shown) at the intersection point 44 of the dual-beam device 36, comprising a FIB column 46 with a FIB optical axis 48 and a charged particle beam (CPB) imaging system 50 with a CPB optical axis 52. At the intersection point 44 of both optical axes of FIB and CPB imaging system, the wafer surface is arranged at slant angle GF to the FlB optical axis 48. The CPB optical axis 52 forms a slant angle GE with the z-axis, which is perpendicular to the wafer plane. With a FIB 54 impinging under a slant angle GF on the surface of the wafer 38, slanted cross-section surfaces are milled into the wafer 38 by ion beam milling at the inspection site 40 under approximately the slant angle GF between 20° and 60°. In the example of FIG. 3, the slant angle GF is approximately 30°. The actual slant angle can deviate from the slant angle GF by up to 1° to 4° due to the beam divergency of the focused ion beam, for example a Gallium-Ion beam. With the charged particle beam imaging system 50 inclined under angle GE to the wafer normal, images of the milled surfaces are acquired. In the example of FIG. 3, the angle GE is below 15°. During imaging, a beam of charged particles is scanned by a scanning unit of the CPB imaging system 50 along a scan path over a cross-section surface of the wafer 38 at measurement site 40, and secondary particles as well as scattered particles are generated. Particle detector 56 collects at least some of the secondary particles and scattered particles and communicates the particle count to a control unit 58. Control unit 58 is in control of the charged particle beam imaging system 50, of the FlB column 46 and the FIB 54, and is connected to a control unit 60 to control the position of the wafer 38 mounted on the wafer support table 42 via the wafer stage (not shown). Control unit 58 communicates with operation unit 62, which triggers placement and alignment, for example, of measurement site 40 of the wafer 38 at the intersection point 44 via wafer stage movement and triggers repeatedly operations of FIB milling, image acquisition and stage movements. Each intersection surface is imaged using an substantially vertical charged particle imaging beam 64, generated by, for example, a scanning electron microscope or any other charged particle beam microscope such as a Helium-Ion microscope (HIM). The process is further described in WO 2021/180600 A1, which is incorporated by reference herein.

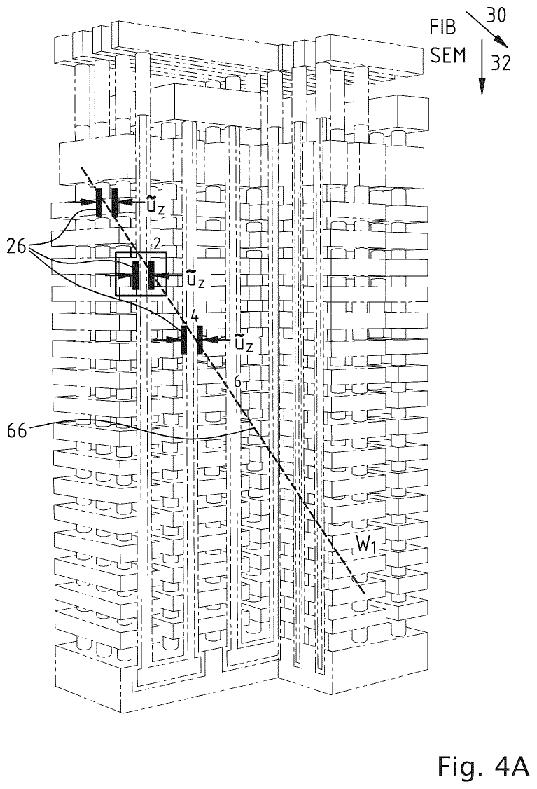

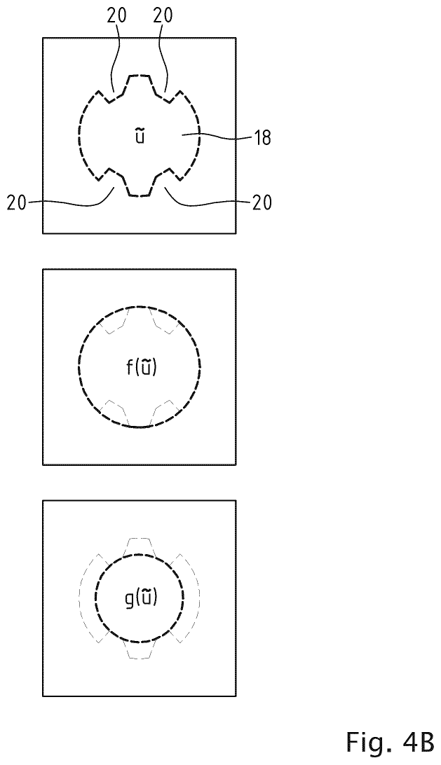

FIG. 4A illustrates a sparse imaging setup for imaging a wedge cut W₁. The desired measurements 26 Hz of the semiconductor structures 18 at different depths in the wafer can all be derived from different lateral positions of the semiconductor structures 18 in a single wedge cut 66. However, the semiconductor structures 18 interact with the interfering structures 20 at varying degrees. As a result, the extracted measurements 26 are influenced by the interfering structures 20 in a non-linear way. FIG. 4B shows these non-linear interactions of interfering structures 20 (here word-lines) with semiconductor structures 18 (here channels) in a wedge cut 66. Thus, linear models are not sufficient to reliably extract measurements from the wedge cut 66. Instead, the objective is to find non-linear functions f and g that compensate for the non-linearity.

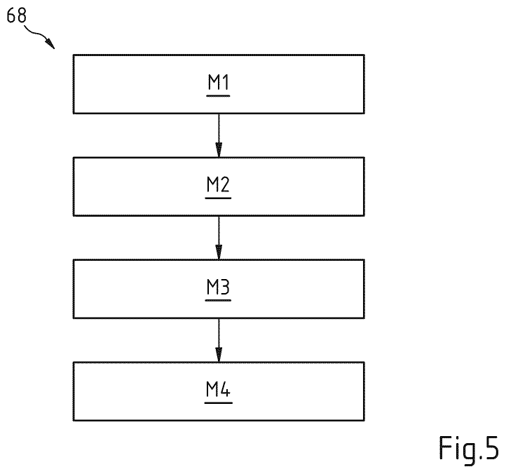

FIG. 5 illustrates a flow chart of a method 68 for obtaining at least one measurement of at least one semiconductor structure in a wafer according to an embodiment of the disclosure. The problem of extracting measurements of high accuracy from a single or multiple wedge cuts 66 is formulated as a machine learning problem. The method 68 for obtaining at least one measurement 26 of at least one semiconductor structure 18 in a wafer 38 comprises: obtaining a wedge cut 66 of an inspection volume of the wafer 38 by exposing a cross section surface 28, 28′ in the inspection volume by milling into the inspection volume with a FIB column 46 at a slant angle GF, and imaging the cross section surface 28, 28′ with a charged particle beam imaging system 50 to obtain the wedge cut 66 in a step M1; extracting a region of interest of the wedge cut 66 comprising a cross section of the at least one semiconductor structure 18 in a step M2; using a trained machine learning model to map the region of interest of the wedge cut 66 to a 3D reconstruction of the region of interest in a step M3; obtaining at least one measurement 26 of the at least one semiconductor structure 18 from the 3D reconstruction of the region of interest of the wedge cut 66 in a step M4.

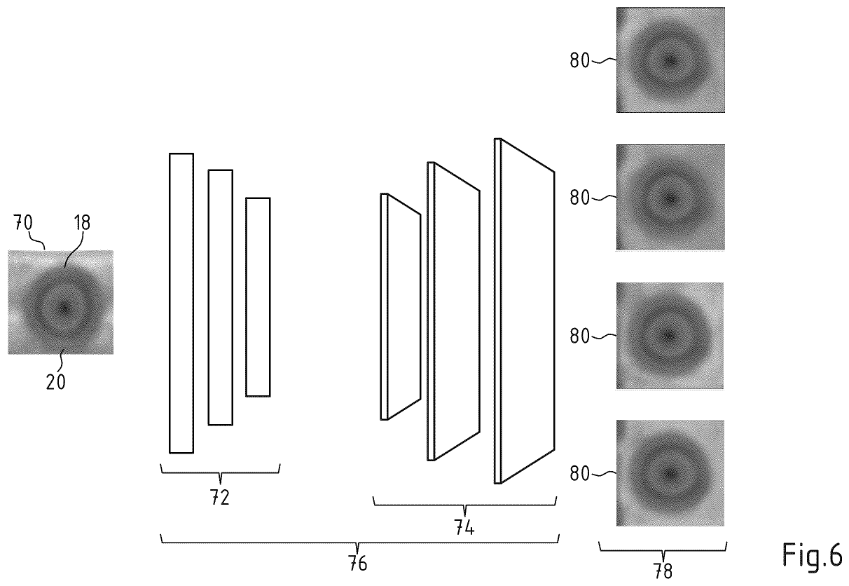

FIG. 6 illustrates the generation of a 3D reconstruction 78 of a region of interest 70 of a wedge cut 66 using a machine learning model 76. The region of interest 70 comprises a semiconductor structure 18 in the form of a channel and an interference structure 20 in the form of a word-line. Thus, the region of interest 70 of the wedge cut 66 comprises one or more interfering structures 20 that affect the at least one measurement 26 of the at least one semiconductor structure 18. The 2D region of interest 70 is presented as input to the machine learning model 76, which maps the 2D region of interest 70 to a 3D reconstruction 78 of the region of interest 70. The 3D reconstruction 78 of the region of interest 70 comprises slices 80 that are parallel to the wafer surface. The number of slices can depend on the depth range of the region of interest 70 in the wedge cut 66. By mapping the 2D region of interest 70 comprising complex interactions of the semiconductor structure 18 and the interfering structure 20 to a 3D reconstruction comprising less complex interactions, measurements 26 can be reliably obtained. In the 3D reconstruction 78 in FIG. 6 the interfering structure 20 in the form of the word-line is almost removed. Thus, measurements 26 can be accurately obtained from the 3D reconstruction 78 of the semiconductor structure 18 instead of using the 2D region of interest 70 of the wedge cut 66.

Apart from 3D reconstructions comprising slices 80 parallel to the wafer surface various other 3D reconstructions 78 of the region of interest 70 can be used. In an example, the 3D reconstruction 78 comprises slices arranged at an angle with respect to the wafer surface. In another example, the 3D reconstruction comprises a 3D voxel-based representation of the region of interest 70 or a 3D graph-based representation of the region of interest. In another example, the 3D reconstruction comprises a set of features of the region of interest 70 arranged in slices parallel to the wafer surface or at an angle with respect to the wafer surface, e.g., contours, edges, polygons, points, geometric shapes, etc. In another example, the 3D reconstruction comprises 3D features of the region of interest 70, e.g., a 3D surface or 3D primitives such as cylinders, spheres, cuboids, etc. In a further example, the 3D reconstruction comprises a segmentation of 3D structures of interest, e.g., HAR structures, films in memory structures, vias, interconnects in logic structures, etc. Alternatively, the 3D reconstruction comprises a super-resolution of structures in spatial or depth direction. In another example, the 3D reconstruction comprises a mesh.

The machine learning model 76 maps a 2D region of interest 70 to a 3D reconstruction, e.g., to a number of slices 80 parallel to the wafer surface as illustrated in FIG. 6. Such cross-domain mappings can be efficiently learned using deep learning, for example U-Net architectures as shown in FIG. 6. A U-Net is a fully convolutional neural network (CNN) with autoencoder structure and skip connections and can be used, e.g., for image reconstruction or image segmentation tasks. To perform cross-domain mappings a 2D encoder can be combined with a 3D decoder as shown in FIG. 6. The 2D encoder uses the vectorized region of interest as input and maps it to spatially reduced feature maps, whereas the 3D decoder maps to spatially increasing 3D feature maps and, finally, returns the 3D reconstruction.

The machine learning model 76 for mapping the region of interest 70 to the 3D reconstruction can be trained using training data comprising regions of interest 70 of wedge cuts 66 and corresponding 3D reconstructions 78. In an example, wafer inspection volumes are obtained, e.g., by acquiring imaging datasets, by using designs or by simulating acquired imaging datasets from designs. The training data is extracted from the inspection volumes by generating wedge cuts 66 from the inspection volumes, selecting 2D regions of interest 70 from the wedge cuts 66 and obtaining the 3D reconstructions as the 3D sub-volumes from the inspection volume that correspond to the selected 2D regions of interest 70 of the wedge cuts 66. Using training data comprising pairs each containing a 2D region of interest 70 from a wedge cut 66 and a corresponding 3D reconstruction from the inspection volume the machine learning model 76 can be trained.

In an example, the inspection volumes of the training data contain slices parallel to the wafer surface as shown in FIG. 2A, such that each region of interest 70 in a wedge cut 66 corresponds to a region of interest in each of a specific number of slices 80 of the inspection volume. The number of slices can depend on the depth range of the region of interest 70 in the wedge cut 66. By training the machine learning model 76 to map a region of interest 70 in a wedge cut 66 comprising complex interactions between semiconductor structures 18 and interfering structures 20 to the corresponding region of interest in multiple slices 80 parallel to the wafer surface, a 3D reconstruction of the region of interest 70 comprising less complex interactions between semiconductor structures 18 and interfering structures 20 is obtained. From this 3D reconstruction measurements 26 can be taken with high accuracy, e.g., by using linear models to model the interactions between semiconductor structures 18 and interfering structures 20, or by only using slices that do not contain interfering structures 20 for obtaining measurements. Since the generation of slices 80 parallel to the wafer surface is only used for training the machine learning model, the application of the machine learning model 76, which directly maps the region of interest 70 to a 3D reconstruction 78, is very fast (e.g., by implementing it on a GPU) and achieves high throughput with little memory.

The machine learning model 76 can, for example, be trained using a loss function comprising the deviation of the estimated 3D reconstruction 78 (obtained by applying the machine learning model to a 2D region of interest 70) from the ground truth 3D reconstruction obtained from the inspection volume of the training data. The deviations can, for example, be measured using the root mean squared error (RMSE) or some norm such as the L₁ norm or the L₂ norm, etc. The loss function can, optionally, comprise the deviation of the gradients of the estimated 3D reconstruction, e.g., of the reconstructed slices 80, from the gradients of the ground truth 3D reconstruction obtained from the inspection volume. The deviation of the gradients can, for example, be measured using a distance transform. The following loss function can, for example, be used:

$$L = R M S E ( 3 D {R}_{est} , 3 D {R}_{gt} ) + d i s t ( {imgrad}_{est} , imgra {d}_{gt} ) ,$$

where 3DRₑₛₜ indicates the estimated 3D reconstruction, 3DR_{gt} indicates the ground truth 3D reconstruction, imgradₑₛₜ indicates the gradients or a gradient image of the estimated 3D reconstruction and imgrad_{gt} indicates the gradients or a gradient image of the ground truth 3D reconstruction.

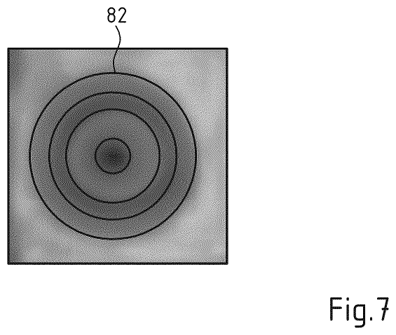

FIG. 7 shows features 82 in the form of four different circles that can be derived from the 3D reconstruction 78 using one or several of the reconstructed slices 80. The semiconductor structure 18 in the form of a channel consists of different materials arranged around the center of the channel. By estimating the diameters of the different circles in FIG. 7 the thickness of the materials can be estimated. Alternatively, the center of the semiconductor structure 18 can be estimated from one of the circle centers. Other measurements 26 can be computed as well. The measurements 26 can be computed using standard image processing or machine learning techniques. For example, contours can be extracted using contour extraction methods such as Active Contours, edges can be extracted using edge detectors, geometric structures such as circles can be derived using Hough transforms, etc. Alternatively, machine learning models can be trained to extract the desired measurements 26 from the 3D reconstruction 78.

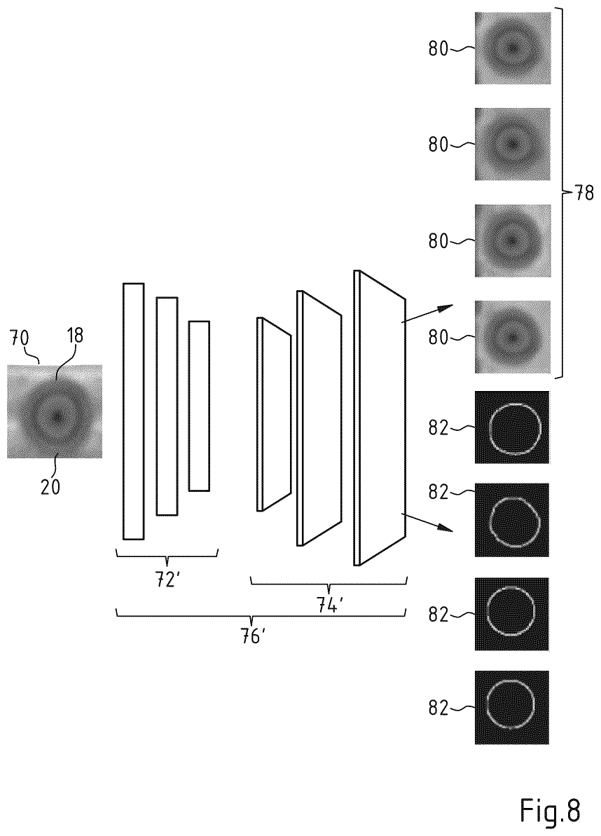

FIG. 8 illustrates the generation of a 3D reconstruction 78 and corresponding features 82 in the form of contours from a region of interest 70 of a wedge cut 66 using a machine learning model 76. The 3D reconstruction comprises slices 80 parallel to the wafer surface. The machine learning model 76′ can be modeled and trained according to the machine learning model 76 described with respect to FIG. 6 with the difference that the output of the model additionally comprises features 82 that can be used for taking measurements 26. In FIG. 8, for example, the output of the machine learning model 76′ additionally contains contour images of the semiconductor structures 18, the channels. The features can, for example, be indicated by binary images as shown in FIG. 8, where 1 indicates a feature pixel and 0 a non-feature pixel, e.g., 1 indicates an edge or contour pixel and 0 indicates a background pixel. Thus, the machine learning model 76′ combines the steps of 3D reconstruction and feature extraction. In this way, the accuracy is improved, since error-prone postprocessing methods are not required and the machine learning model directly learns the optimal features for a given region of interest 70 from the training data. In addition, computation time is reduced and the throughput increased, since postprocessing methods are not required.

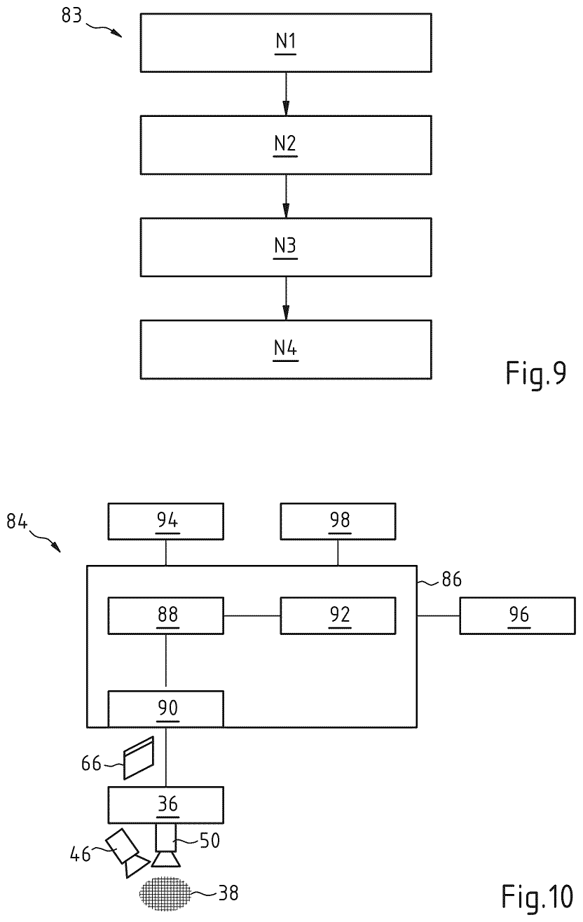

FIG. 9 illustrates a flow chart of a method 83 for obtaining at least one measurement of at least one semiconductor structure in a wafer according to an embodiment of the disclosure. The method comprises the following steps: obtaining a number N≥2 of wedge cuts of an inspection volume of the wafer by exposing N different cross section surfaces in the inspection volume by milling into the inspection volume with a FIB column at different slant angles GF, and imaging each cross section surface with a charged particle beam imaging system to obtain each of the N wedge cuts in a step N1; extracting a region of interest comprising a cross section of the at least one semiconductor structure of each of the N wedge cuts in a step N2; using a trained machine learning model to map the N regions of interest of the N wedge cuts to a 3D reconstruction of the N regions of interest in a step N3; obtaining at least one measurement of the at least one semiconductor structure from the 3D reconstruction of the N regions of interest of the N wedge cuts in a step N4. The methods and concepts described above can be applied to this embodiment accordingly. For example, the machine learning model can be trained to use at least two wedge cuts as input and map these wedge cuts to a 3D reconstruction. The training data can be extracted from the inspection volumes as described above. Using training data comprising pairs each containing at least two 2D regions of interest from a wedge cut, each region of interest comprising the same at least one semiconductor structure, and a corresponding 3D reconstruction of the at least two 2D regions of interest from the inspection volume the machine learning model 76 can be trained. The same loss function described above can be applied. The method according to this embodiment uses additional input data in the form of additional wedge cuts. In this way, the accuracy can be even further improved at the cost of a slightly higher runtime and slightly lower throughput. The examples described above with reference to obtaining a 3D reconstruction of one wedge cut can be applied accordingly to the case of obtaining a 3D reconstruction of at least two wedge cuts.

In an example, the two or more wedge cuts 66 are of two different modalities by detecting different kinds of radiation emitted from the wafer. For example, the at least two wedge cuts 66 can be obtained using different types of detectors, e.g., an InLens detector for collecting secondary electrons generated by direct interaction of the wafer with the incident electron beam, or a secondary electron secondary ion (SESI) detector for collecting back-scattered electrons. Wedge cuts 66 obtained using different types of detectors contain different material or morphological information that can be useful for obtaining measurements of semiconductor structures.

According to an example, the methods 68, 83 for obtaining at least one measurement 26 of at least one semiconductor structure 18 further comprise providing an uncertainty measure for the at least one measurement 26 of the at least one semiconductor structure 18. Such uncertainty measures can, for example, be provided by the machine learning model 76, 76′ itself. For example, an uncertainty measure can be obtained by using an ensemble of models or a probabilistic model, e.g., variational autoencoders, or by using Monte-Carlo dropout, e.g., in case of a single model. Alternatively, an uncertainty measure can be derived from the 3D reconstruction 86, e.g., by comparing the deviation of the features or measurements at different depths in the 3D reconstruction 86, or by deriving statistics of these parameters. For example, in FIG. 6 or FIG. 8 the deviation of the diameters of the circles in different slices 80 of the 3D reconstruction can be compared. For example, the variance or higher order moments of these diameters could be used as uncertainty measure. By applying a threshold to the uncertainty measure, incorrect 3D reconstructions could be detected. Alternatively, a high uncertainty can also indicate a defect in the semiconductor structure.

In case of repetitive structures such as memory structures, defects could be detected by comparing the deviation of the measurements obtained from different semiconductor structures in a single or multiple wedge cuts.

FIG. 10 schematically illustrates a system 84 according to an embodiment of the disclosure, which can be used for obtaining at least one measurement of at least one semiconductor structure on a wafer 38. The system 84 includes a dual beam device 36 and a processing device 86. The dual beam device 36 is coupled to the processing device 86, e.g., via cable or wireless. The dual beam device 36 comprises a FIB column 46 and a CPB imaging system 50 and is configured to acquire wedge cuts 66 of the wafer 38. Alternatively, ion milling can be used to acquire wedge cuts 66 of the wafer. During ion milling, a kind of crater is mechanically carved out of the wafer, and a depth profile of the wafer is obtained by imaging various radial positions within the crater.

The dual beam device 36 can provide a wedge cut 66 to the processing device 86. The processing device 86 includes one or more processors 88, e.g., implemented as a CPU or GPU. The one or more processors 88 can receive the wedge cut 66 via an interface 90. The one or more processors 88 can load program code from one or more machine-readable hardware storage devices 92. The one or more processors 88 can execute the program code. Upon executing the program code, the one or more processors 88 perform techniques such as described herein, e.g., obtaining measurements of semiconductor structures in a wafer 38, generating 3D reconstructions from 2D regions of interest of wedge cuts 66, obtaining features from 3D reconstructions, training and/or applying a machine learning model for 3D reconstruction and, optionally, feature extraction, performing image processing tasks for obtaining features and/or measurements from the 3D reconstruction, etc. For example, the one or more processors 88 can perform the method shown in FIG. 5 or FIG. 9, respectively, upon loading program code from the one or more machine-readable hardware storage device 92. The system 84 can optionally contain a user interface 94, e.g., for carrying out the training of the machine learning model, for setting parameters, for indicating measurement specifications, for natural language processing, for reviewing of associated measurement specifications, etc. The system 84 can optionally contain a database 96. The database 96 can, for example, be used to load sets of measurement specifications, training data, trained or pre-trained machine learning models, etc. The system 84 can optionally contain a visualization device 98 for visualizing 3D reconstructions, regions of interest, features, measurements, measurement specifications, etc., to the user.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

The disclosure can be described by the following clauses:
1. A method 68 for obtaining at least one measurement 26 of at least one semiconductor structure 18 in a wafer 38, the method 68 comprising:
   obtaining a wedge cut 66 of an inspection volume of the wafer 38 by exposing a cross section surface in the inspection volume by milling into the inspection volume with a FIB column 46 at a slant angle GF, and imaging the cross section surface with a charged particle beam imaging system 50 to obtain the wedge cut 66;
   extracting a region of interest 70 of the wedge cut 66 comprising a cross section of the at least one semiconductor structure 18;
   using a trained machine learning model 76, 76′ to map the region of interest 70 of the wedge cut 66 to a 3D reconstruction 78 of the region of interest 70; and
   obtaining at least one measurement 26 of the at least one semiconductor structure 18 from the 3D reconstruction 78 of the region of interest 70 of the wedge cut 66.
2. The method of any one of the preceding clauses, wherein the region of interest 70 of the wedge cut 66 comprises one or more interfering structures 20 that affect the at least one measurement 26 of the at least one semiconductor structure 18.
3. The method of clause 2, wherein the one or more interfering structures 20 are oriented in a direction parallel to the wafer surface at specific depths 24 in the wafer 38.
4. The method of clause 2 or 3, wherein the one or more interfering structures 20 are from the group comprising word-lines and deck-transitions.
5. The method of any one of the preceding clauses, wherein the depth range of the 3D reconstruction 78 of the region of interest 70 corresponds to the depth range of the region of interest 70 in the wedge cut 66.
6. The method of any one of the preceding clauses, wherein the 3D reconstruction 78 of the region of interest 70 comprises slices 80 that are parallel to the wafer surface.
7. The method of clause 6, wherein the region of interest 70 of the wedge cut 66 comprises an interfering structure 20 that affects the measurement 26 and wherein at least one slice 80 of the 3D reconstruction 78 does not contain the interfering structure 20.
8. The method of any one of the preceding clauses, wherein at least one semiconductor structure 18 is a high aspect ratio structure.
9. The method of any one of the preceding clauses, wherein the at least one measurement 26 is from the group comprising a position, a radius, a diameter, a length, a distance, an area, an angle, an ellipticity, an aspect ratio, a curvature, a periodicity, a polygon parameter, a tilt.
10. The method of any one of the preceding clauses, wherein the trained machine learning model 76′ additionally maps the extracted region of interest 70 of the wedge cut 66 to one or more features 82 of the at least one semiconductor structure 18.
11. The method of clause 10, wherein a feature 82 of the semiconductor structure 18 is from the group comprising a contour, a contour section, a point, a line, a geometric structure, an edge.
12. The method of any one of the preceding clauses, wherein a number N≥2 of wedge cuts 66 of the inspection volume of the wafer 38 for different slant angles GF are obtained, and wherein a region of interest 70 comprising a cross section of the at least one semiconductor structure 18 is extracted from each wedge cut 66, wherein the trained machine learning model 76, 76′ maps the N regions of interest 70 of the N wedge cuts 66 to a 3D reconstruction 78 of the N regions of interest 70, and wherein at least one measurement 26 of the at least one semiconductor structure 18 is obtained from the 3D reconstruction 78 of the N regions of interest 70 of the N wedge cuts 66.
13. The method clause 12, wherein the wedge cuts 66 are of at least two different modalities by detecting different kinds of radiation emitted from the wafer
14. The method of any one of the preceding clauses, wherein the slant angle GF lies within the range of 250 and 45°, preferably within the range of 300 and 36°, relative to the wafer surface.
15. The method of any one of the preceding clauses, further providing an uncertainty measure for the at least one measurement 26 of the at least one semiconductor structure 18.
16. A computer implemented method for training a machine learning model 76, 76′, which maps one or more regions of interest 70 of one or more wedge cuts 66 to a 3D reconstruction 78 of the one or more regions of interest 70, for use of the trained machine learning model 76, 76′ in a method according to any one of clauses 1 to 15.
17. The method of clause 16, wherein the training data for training the machine learning model 76, 76′ comprises regions of interest 70 of wedge cuts 66 and corresponding 3D reconstructions 78.
18. The method of clause 17, wherein the training data is obtained from one or more 3D inspection volumes of wafers 38 comprising slices parallel to the wafer surface and wedge cuts 66 through the one or more 3D inspection volumes.
19. A computer program comprising instructions which, when the program is executed by a computer, cause the computer to carry out a method of any one of clauses 1 to 18.
20. A computer-readable medium, on which a computer program executable by a computing device is stored, the computer program comprising code for executing a method of any one of clauses 1 to 18.
21. A system 84 comprising:
   a dual beam device 36 comprising a charged particle beam imaging system 50 and a FIB column 46 configured to obtain at least one wedge cut 66 of a wafer 38;
   one or more processing devices 86; and
   one or more machine-readable hardware storage devices 92 comprising instructions that are executable by the one or more processing devices 86 to perform operations comprising a method of any one of clauses 1 to 18.

In summary, embodiments of the disclosure relate to a method for obtaining at least one measurement 26 of at least one semiconductor structure in a wafer comprising: obtaining a wedge cut 66 of an inspection volume of the wafer by exposing a cross section surface in the inspection volume by milling into the inspection volume with a FIB column at a slant angle GF, and imaging the cross section surface with a charged particle beam imaging system; extracting a region of interest of the wedge cut 66 comprising a cross section of the at least one semiconductor structure; using a trained machine learning model to map the region of interest of the wedge cut 66 to a 3D reconstruction of the region of interest; obtaining at least one measurement 26 from the 3D reconstruction.

Reference number list

| | |
|---|---|
| 10 | 3D memory structure |
| 12 | Bit line |
| 14 | Source line |
| 16 | Select gate |
| 18 | Semiconductor structure |
| 20 | Interfering structure |
| 22 | Back gate |
| 24 | Depth |
| 26 | Measurement |
| 28 | Interference-free cross section |
| 28′ | Interfered cross section |
| 30 | FIB direction |
| 32 | SEM direction |
| 34 | Interference-free cross section image |
| 34′ | Interfered cross section image |
| 36 | Dual beam device |
| 38 | Wafer |
| 40 | Measurement site |
| 42 | Wafer support table |
| 44 | Intersection point |
| 46 | FIB column |
| 48 | FIB Optical axis |
| 50 | Charged particle beam imaging system |
| 52 | CPB Optical axis |
| 54 | FIB |
| 56 | Particle detector |
| 58 | Control unit |
| 60 | Control unit |
| 62 | Operation unit |
| 64 | Charged particle imaging beam |

66 Wedge cut
68 Method
70 Region of interest
72, 72′ 2D encoder
74, 74′ 3D decoder
76, 76′ Machine learning model
78 3D reconstruction
80 Slice
82 Feature
83 Method
84 System
86 Processing device
88 Processor
90 Interface
92 Hardware storage device
94 User interface
96 Database
98 Visualization device

What is claimed is:

1. A method of obtaining a measurement of a semiconductor structure in a wafer, the method comprising:
using a FIB column to mill into an inspection volume of the wafer to expose a cross-section surface in the inspection volume, the FIB column being arranged at a slant angle relative to a surface of the wafer;
imaging the cross section surface with a charged particle beam imaging system to obtain a two dimensional (2D) image of the cross section surface;
extracting a region of interest of the cross section surface, the region of interest comprising a cross section of the semiconductor structure;
using a trained machine learning model to map the region of interest to a three dimensional (3D) reconstruction of the region of interest; and
obtaining the measurement of the semiconductor structure from the 3D reconstruction of the region of interest.

2. The method of claim 1, wherein the region of interest comprises an interfering structure that affects the measurement of the semiconductor structure.

3. The method of claim 2, wherein:
the interfering structure is oriented in a direction parallel to the surface of the wafer at specific depths in the wafer; and/or
the interfering structure comprises a member selected from the group consisting of word-lines and deck-transitions.

4. The method of claim 1, wherein a depth range of the 3D reconstruction of the region of interest corresponds to a depth range of the region of interest in the 2D image of the cross section.

5. The method of claim 1, wherein the 3D reconstruction of the region of interest comprises slices that are parallel to the surface of the wafer.

6. The method of claim 5, wherein the region of interest comprises an interfering structure that affects the measurement, and at least one slice of the 3D reconstruction does not contain the interfering structure.

7. The method of claim 1, wherein the semiconductor structure is a high aspect ratio semiconductor structure.

8. The method of claim 1, wherein the measurement comprises a member selected from the group consisting of a position, a radius, a diameter, a length, a distance, an area, an angle, an ellipticity, an aspect ratio, a curvature, a periodicity, a polygon parameter, and a tilt.

9. The method of claim 1, wherein the trained machine learning model maps the extracted region of interest to a feature of the semiconductor structure.

10. The method of claim 9, wherein the feature comprises a member selected from the group consisting of a contour, a contour section, a point, a line, a geometric structure, and an edge.

11. The method of claim 1, comprising, for each of a plurality of a plurality of cross section surfaces of the inspection volume:
using the FIB column to mill into an inspection volume of the wafer to expose the cross-section surface in the inspection volume, the FIB column being arranged at a slant angle relative to the surface of the wafer;
imaging the cross section surface with a charged particle beam imaging system to obtain a 2D image of the cross section surface;
extracting a region of interest of the cross section surface, the region of interest comprising a cross section of the semiconductor structure;
using a trained machine learning model to map the region of interest to a 3D reconstruction of the region of interest; and
obtaining the measurement of the semiconductor structure from the 3D reconstruction of the region of interest,
wherein, for each cross section surface, the slant angle of the FIB column is different from the slant angle of the FIB for the other cross section surfaces.

12. The method claim 11, wherein:
for a first cross section of the plurality of cross sections, a first kind of radiation is detected when imaging the cross section;
for a second cross section of the plurality of cross sections, a second kind of radiation is detected when imaging the cross section;
the first cross section is different from the second cross section; and
the first kind of radiation is different from the second kind of radiation.

13. The method of claim 1, wherein the slant angle is from 250 to 45°.

14. The method of claim 1, further comprising providing an uncertainty measure for the measurement of the semiconductor structure.

15. A method, comprising:
training a machine learning model to map a region of interest of a cross section surface in an inspection volume of a wafer to a three dimensional (3D) reconstruction of the region of interest so that the trained machine learning model is implementable in a method which comprises obtaining a measurement of a semiconductor structure from the 3D reconstruction of the region of interest,
wherein the region of interest comprises a cross section of the semiconductor structure.

16. The method of claim 15, wherein training data for training the machine learning model comprises regions of interest of 2D images of cross section surfaces of the wafer and corresponding 3D reconstructions.

17. The method of claim 16, comprising obtaining the training data from 3D inspection volumes of wafers comprising slices parallel to the surfaces of the wafers and 2D images of cross section surfaces of the wafers through the 3D inspection volumes.

18. One or more machine-readable hardware storage devices comprising instructions that are executable by one or more processing devices to perform operations comprising the method of claim 1.

19. A system, comprising:
one or more processing devices; and
one or more machine-readable hardware storage devices comprising instructions that are executable by one or more processing devices to perform operations comprising the method of claim 1.

20. The system of claim 19, further comprising a dual beam device, wherein the dual beam device comprises:
the FIB column; and
the charged particle beam imaging system.
